(19) United States
(12) Patent Application Publication
(10) Pub. No.: US 2017/0101167 A1
(43) Pub. Date: Apr. 13, 2017

(54) POWER SYSTEM FOR MARINE VESSELS

(71) Applicant: Diamond Offshore Drilling, Inc., Houston, TX (US)

(72) Inventors: Donald Paul Howard, Houston, TX (US); William Lee Dean, Houston, TX (US)

(73) Assignee: Diamond Offshore Drilling, Inc., Houston, TX (US)

(21) Appl. No.: 15/292,558

(22) Filed: Oct. 13, 2016

Related U.S. Application Data
(60) Provisional application No. 62/240,858, filed on Oct. 13, 2015.

(51) Int. Cl. B63H 25/42; B60L 3/12; G01L 5/13; G05D 1/02

(52) U.S. Cl. CPC B63H 25/42; G05D 1/0206; B60L 3/12; G01L 5/133; B63J 2099/006

(57) ABSTRACT

A system for dynamic positioning of a vessel includes a number of generators that generate electrical power. The system also includes a power distribution system having a first bus that obtains a first portion of the electrical power from a first portion of the plurality of generators and a second bus that obtains a second portion of the electrical power from a second portion of the plurality of generators. The system further includes a thruster that generates thrust using the first portion of the electrical power and the second portion of the electrical power.

### CROSS-REFERENCE TO RELATED APPLICATIONS

This application is a non-provisional patent application of U.S. Provisional Patent Application Ser. No. 62/240,858, filed on Oct. 13, 2015, and entitled: “Power System for Marine Vessels.” Accordingly, this non-provisional patent application claims priority to U.S. Provisional Patent Application Ser. No. 62/240,858 under 35 U.S.C. §119(e). U.S. Provisional Patent Application Ser. No. 62/240,858 is hereby incorporated in its entirety.

### BACKGROUND

Valuable resources, such as hydrocarbon bearing fluids, are obtained geologic formations. Some geological formations are subsurface, e.g., subterranean, and the valuable resources are retrieved from the subterranean geological formations by drilling a well. The well enables the valuable resources to be extracted from the geological formation.

Geological formations may be located on land or below a body of water. For example, subterranean formations that contain oil and natural gas have been found below the Gulf of Mexico which is located near the southern border of the United States. Drilling a well and extracting resources from a geological formation located under a body of water are sometimes facilitated by the use of a marine vessel.

FIG. 1 shows an example of a marine vessel (100) located on a body of water. A geological formation (110) containing valuable resources is located below the bottom (120) of the body of water.

To retrieve valuable resources from the geological formation (110), one or more pieces of subsea equipment (130) are located on the bottom (120). The subsea equipment (130) may control the operation of a well (125) that enables the valuable resources within the geological formation (110) to be extracted.

The subsea equipment (130) and the well (125) may be installed and drilled, respectively, by equipment (140) of the marine vessel (100) that is linked by risers (150) to the site of the well (125) and subsea equipment (130). As used herein, risers (150) may be structures that form a mechanical connection between the marine vessel (100) and the site of the well and/or subsea equipment (130). The risers (150) may include multiple flow lines to facilitate sending fluids to the site and retrieving valuable resources from the site. The risers (150) may also include hydraulic lines, electric power distribution lines, and/or other types of equipment as necessary to facilitate the construction of the well (125), installation of the subsea equipment (130), and operation of the completed well (125).

The mechanical link, between the site of the well (125) and the marine vessel (100) formed by the risers (150), may be degraded and/or broken if the marine vessel (100) is displaced a sufficient distance from an axis (155) of the well (125). As the displacement distance (156) between the vessel (100) and the axis of the well increases, forces acting on the attachment point (160) of the risers (150) to the marine vessel (100) and the attachment point (165) of the risers (150) to the well (125) or subsea equipment (130) increases. For example, the forces acting on a well head of the subsea equipment (130) by the risers (150) may exceed a maximum axial load rating of the well head resulting in damage to the well head and/or risers (150).

To prevent displacement of the marine vessel (100) caused by, for example, waves, ocean currents, air currents, or any other force, from damaging the mechanical connections to the risers (150), the position of the marine vessel (100) may be maintained by mooring to one or more anchors (170). The anchors (170) may be embedded or otherwise attached to the bottom (120) and connected to the marine vessel (100) by one or more anchor lines. The location of each anchor (170) and the length of each anchor line may prevent the marine vessel (100) from being displaced by the waves, ocean currents, air currents, or other forces acting on the marine vessel (100).

### SUMMARY

In one aspect, a system for dynamic positioning of a vessel in accordance with embodiments of the invention includes a number of generators that generate electrical power. The system also includes a power distribution system having a first bus that obtains a first portion of the electrical power from a first portion of the plurality of generators and a second bus that obtains a second portion of the electrical power from a second portion of the plurality of generators. The system further includes a thruster that generates thrust using the first portion of the electrical power and the second portion of the electrical power

In another aspect, a method for performing dynamic positioning of a vessel in accordance with embodiments of the invention includes obtaining a state of a bus of the vessel. The method includes determining a quantity of thrust to be generated by a thruster of the vessel based on, at least in part, the state of the bus. The method further includes setting a thrust generation rate of a thruster of the vessel based on the quantity of thrust to be generated.

### BRIEF DESCRIPTION OF DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIG. 1 shows a diagram of an example of a marine vessel.

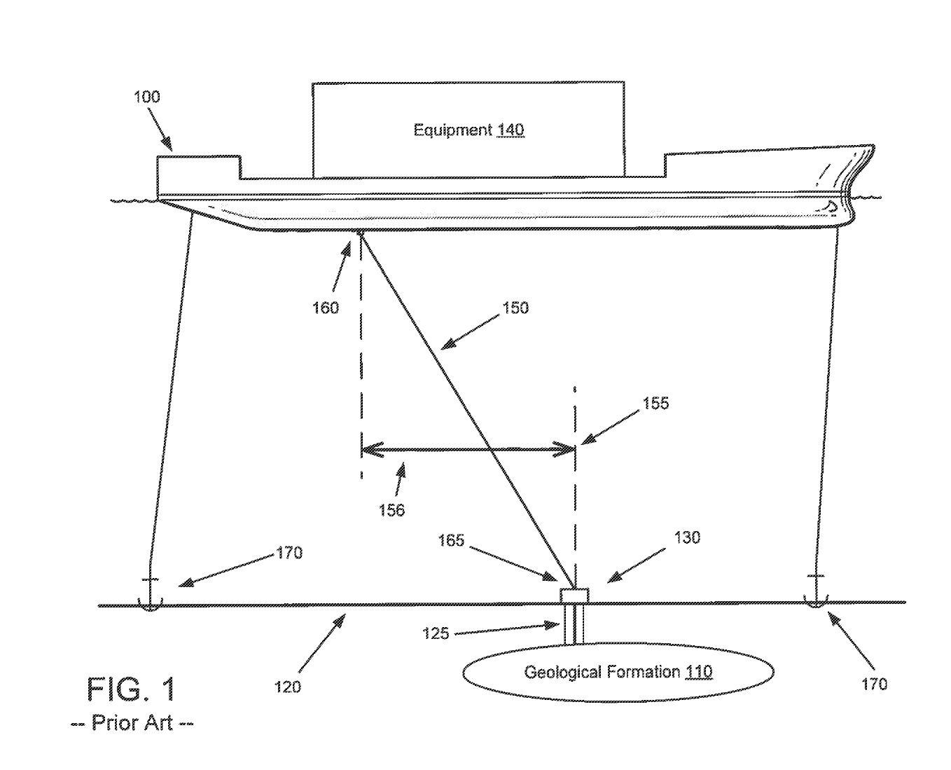

FIG. 2A shows an isometric diagram of a vessel in accordance with one or more embodiments.

FIG. 2B shows a side view diagram of the vessel in accordance with one or more embodiments,

FIG. 3A shows a schematic diagram of the vessel in accordance with one or more embodiments of the invention.

FIG. 3B shows a control diagram of the vessel in accordance with one or more embodiments of the invention.

FIG. 4 shows a schematic diagram of a power generation system in accordance with one or more embodiments.

FIG. 5 shows a schematic diagram of a power distribution system in accordance with one or more embodiments.

FIG. 6A shows a schematic diagram of an example drive system in accordance with one or more embodiments of the invention.

FIG. 6B shows a schematic diagram of a second example drive system in accordance with one or more embodiments of the invention.

FIG. 7 shows a schematic diagram of a controller in accordance with one or more embodiments of the invention.

FIG. 8 shows a flowchart in accordance with one or more embodiments of the invention.

### DETAILED DESCRIPTION

Specific embodiments of the technology will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Additionally, numbered elements shown in each figure are similarly numbered in each other figure.

In general, embodiments of the invention include devices, systems, and methods for performing dynamic positioning of a vessel. As used herein, dynamic positioning is a method of maintaining the location of the vessel within a predetermined area by generating and controlling thrust. The location may be relative with respect to a local feature within the surrounding environment, e.g., a specific geological formation, subsea equipment, or a wellsite. The vessel may be a boat, platform, or any other seafaring structure.

Ocean currents, for example, apply force to an unpowered or untethered vessel that causes the vessel to drift in the direction of the currents. Similarly, air currents, waves, and other forces also cause unpowered or untethered vessels to drift in response to the applied forces. Additionally, at any time, multiple forces, e.g., ocean currents and air currents, may apply multiple forces to a vessel that may cause the vessel to drift, list, and/or rotate in response to the applied forces.

To maintain the position of the vessel with respect to the local feature, embodiments of the invention may utilize at least one thruster to counteract local forces exerted on the vessel by generating a counteracting thrust. As used herein, a thruster is a jet, propeller, or other device for generating thrust by interacting with a fluid, e.g., an ocean, lake, gulf, or other body of water. The thruster may include an electric motor, powered by electrical current, that is mechanically coupled to a propeller or other thrust generating device. The thruster may include other motors or other systems for directing the thrust generated by the thruster.

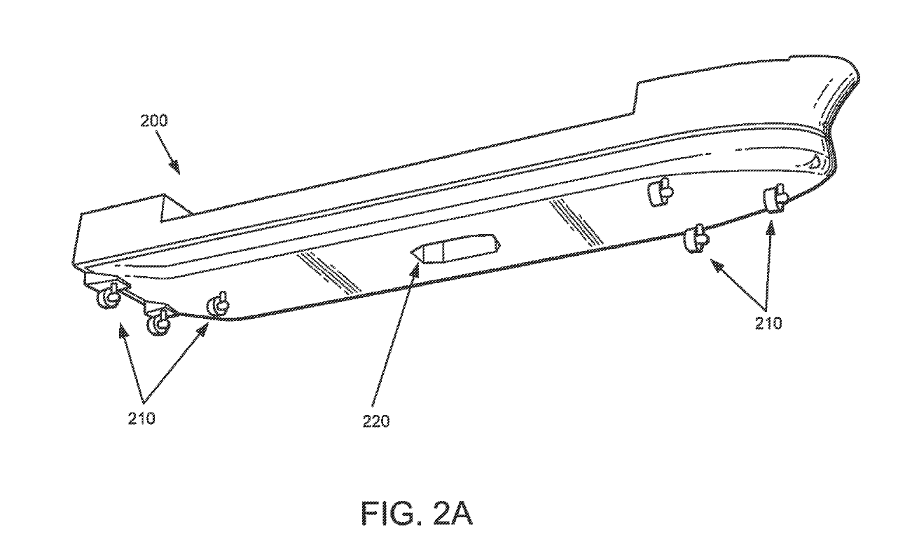

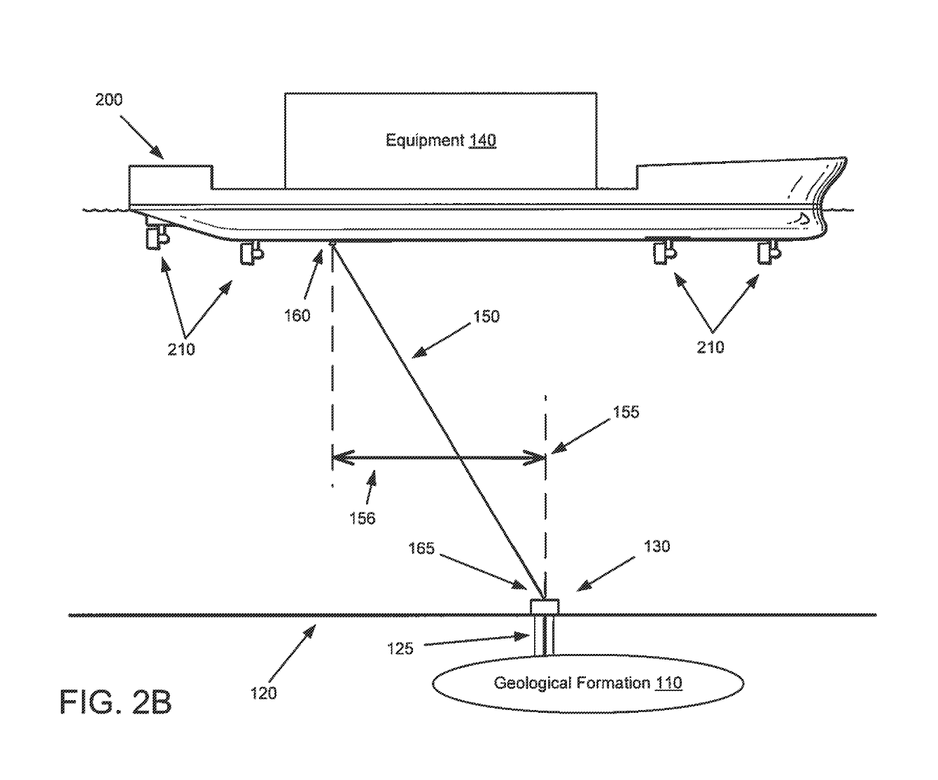

FIG. 2A shows an isometric diagram of a vessel (200) in accordance with embodiments of the invention. The vessel may be a marine vessel that operates on a body of water. The vessel (200) includes thrusters (210) and a moon pool (220). As described above, the thrusters (210) may be used to produce thrust to counteract forces exerted on the vessel (200) and thereby may dynamically maintain the position of the vessel (200) with respect to a well site, a subsea equipment, a geological formation, or any other predetermined location.

The moon pool (220) may enable equipment (not shown) disposed in or the vessel (200) to access a wellsite or subsea equipment disposed outside the vessel (200). For example, as will be further described with respect to FIG. 2B, the moon pool (200) may enable access to risers that connect the equipment to the wellsite or subsea equipment. The moon pool (220) may be an opening in the hull of the vessel (200).

FIG. 2B shows a side view diagram of the vessel (200) in accordance with embodiments of the invention. As seen from FIG. 2B, the thrusters (210) may be disposed along the length of the vessel (200). The equipment (140), disposed within and/or on the vessel (200), may be linked to a wellsite or subsea equipment (130) by the risers (150).

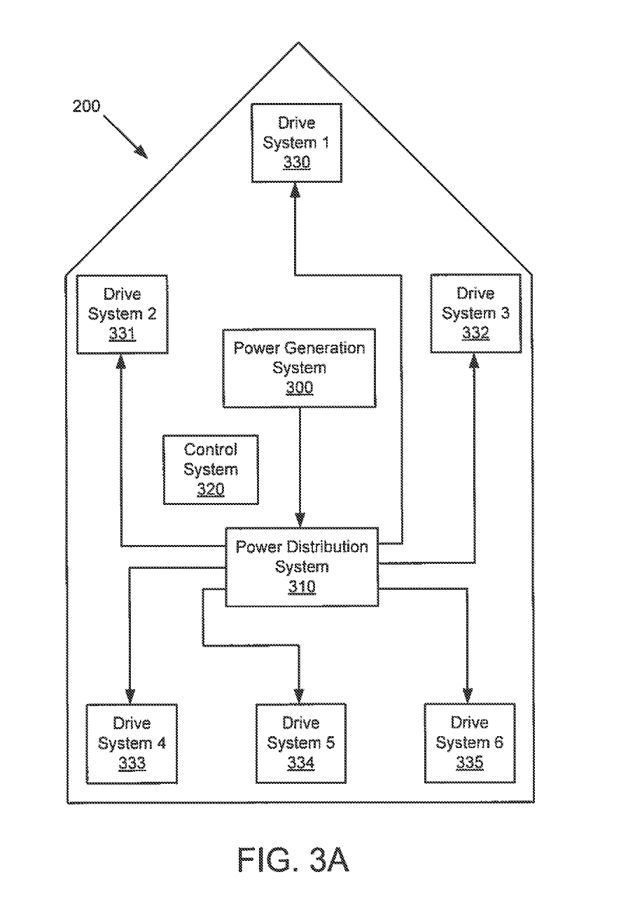

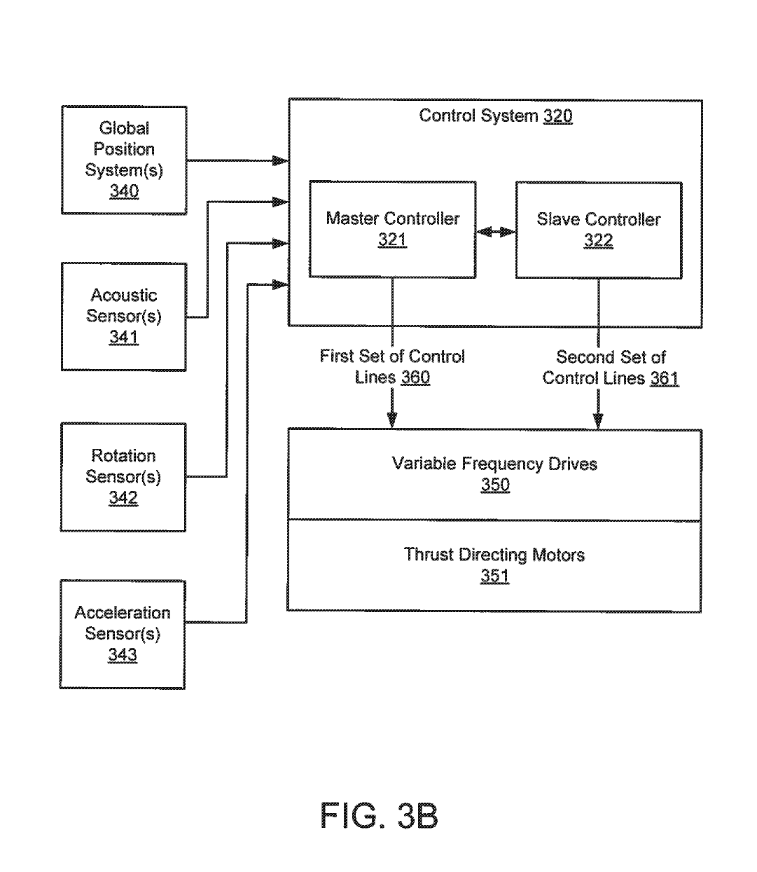

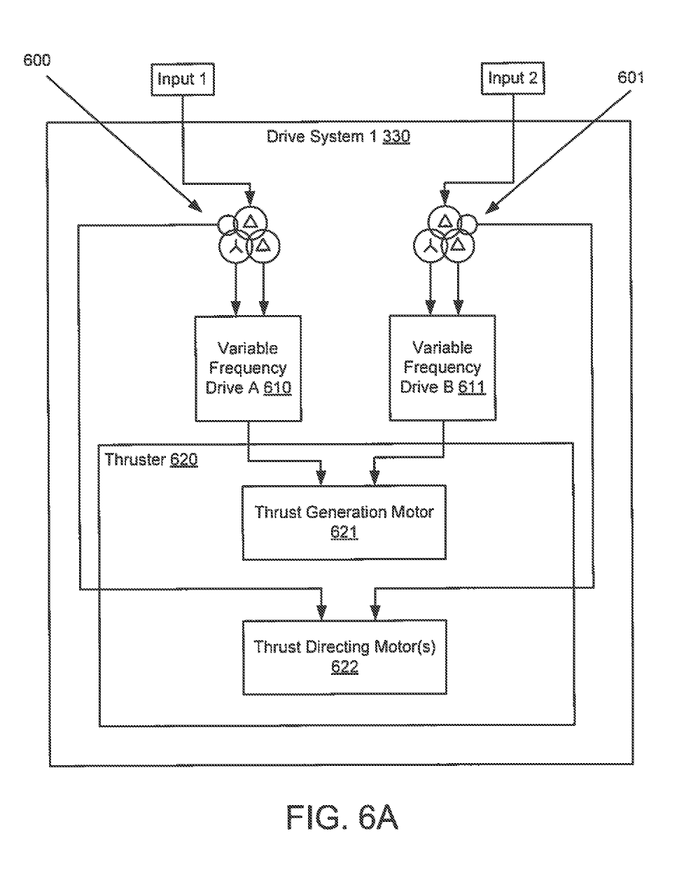

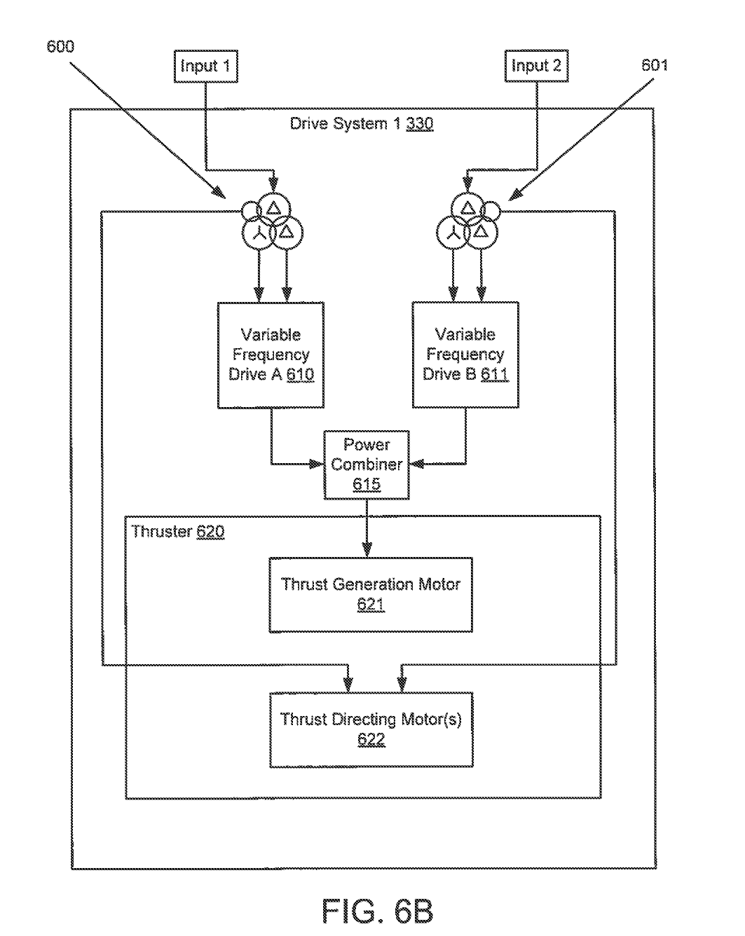

To prevent the vessel (200) from being displaced a sufficient displacement distance (156) by ambient forces to cause damage to one of the connections of the risers (150), the thrusters (210) may be operated to dynamically position the vessel with respect to the subsea equipment (130). More specifically, the thrusters (210) may produce and direct thrust to counteract forces acting on the vessel (200). A control system, as will be discussed in greater detail with respect to FIGS. 3A and 3B, may control the thrusters by setting a quantity and direction of thrust generated by each thruster and thereby maintain the relative position of the vessel with respect to a site. The control system may set the quantity of thrust by controlling a quantity of power supplied to a thruster by a variable frequency drive and may set the direction of the thrust by operating a thrust directing motor of the thruster, as will be described in greater detail with respect to FIGS. 6A and 6B.

Returning to FIG. 2B, the thrusters (210) may be electrically powered. If electrical power is not supplied to the thrusters (210), the vessel (200) will not be able to counteract ambient forces acting on the vessel by generating thrust by the thrusters.

FIG. 3A shows a power flow diagram of the vessel (200) in accordance with one or more embodiments of the invention. The arrows in FIG. 3A indicate a direction of power flow. The vessel (200) includes multiple systems that act to ensure that the thrusters of the vessel (200) are supplied power, even in the event of failure of multiple generators of the vessel (200), and thereby prevent a displacement distance (156, FIGS. 2A, 2B) from exceeding a distance, that could damage the risers (150. FIGS. 2A, 2B), by ensuring the operation of the thrusters. As seen from FIG. 3A, the vessel (200) includes a power generation system (300), a power distribution system (310), a control system (320), and drive systems (330-335). Each of the aforementioned components are described below.

The power generation system (300) may generate electric power. The power generation system (300) may produce power by burning any type of fuel in, for example, diesel-powered generators that convert mechanical energy to electrical power. As used herein, the electrical power generated by the generators refers to the aggregate quantity of electrical power generated by the generators.

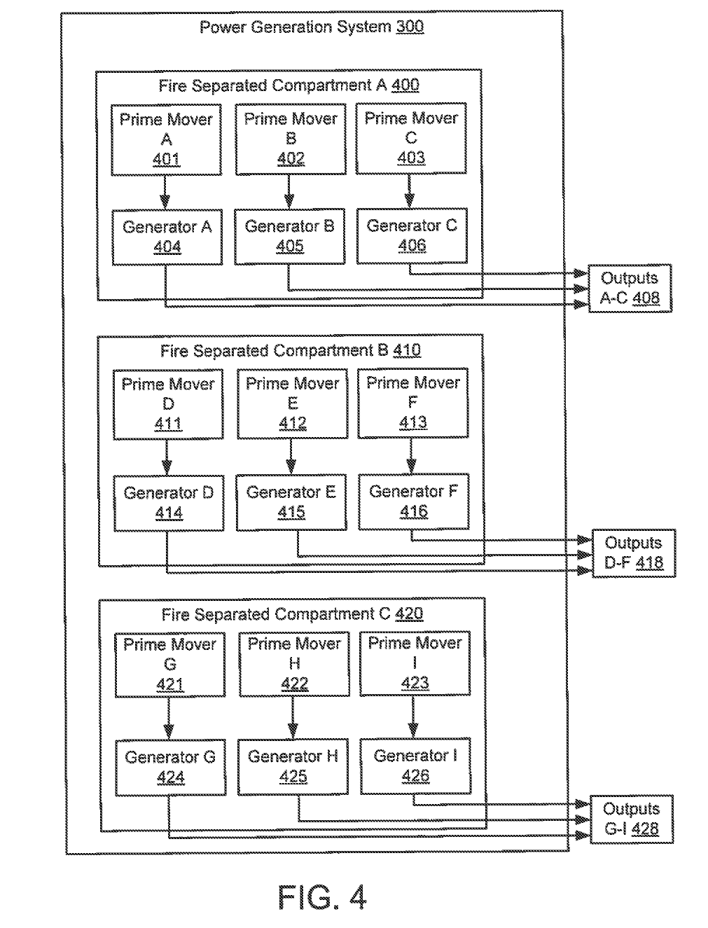

FIG. 4 shows a diagram of the power generation system (300) in accordance with embodiments of the invention. The power generation system (300) includes multiple fire separated compartments (400, 410, 420). Each fire separated compartment may include prime movers and generators coupled to each other.

For example, fire separated compartment A (400) includes prime mover A (401) coupled to generator A (404), prime mover B (402) coupled to generator B (405), and prime mover C (403) coupled to generator C (406). Prime mover A (401) may be a diesel engine that produces rotational motion when operated. Each of the generators (404, 405, 406) may be mechanically coupled to the rotational motion generated by prime mover A (401), prime mover B (402), and prime mover C (403), respectively. The generators (404, 405, 406) generate alternating electric current in response to the cyclical motion generated by the prime movers. Each of the generators (404, 405, 406) may produce an independent electric current output A-C (408), respectively.

Fire separated compartment B (410) and fire separated compartment C (420) include similar components to those of fire separated compartment A (400) and produce similar outputs, e.g., outputs D-F (418) and outputs G-I (428).

The prime movers and generators in each of the fire separated compartments may be configured to generate any quantity of power. For example, the prime movers and generators may be configured to produce a sufficient amount of power to operate all of the thrusters of the vessels and all of the equipment on board the vessel concurrently.

While not shown in FIG. 4, the power system (300) may include regulators that regulate both the magnitude of the electrical current and the phase of the electric current generated by each generator. In other words, the regulators may synchronize the phase of the current generated by each generator to the current generated by each other generator and the regulators may regulate the magnitude of the current so that each generator produces the same electric current magnitude. The regulators may be physical devices including circuitry, electronic components, and/or switching equipment. The regulators may be digital controllers, analog controllers, and/or feedback driven loops.

Additionally, while FIG. 4 illustrates the power generation system (300) as having three fire separated compartments, the power generation system (300) may have other quantities of fire separated compartments without departing from the invention. Similarly, while each fire separated compartment is illustrated as having three prime movers, three generators, and three outputs, other quantities of prime movers, generators, and outputs may be used without departing from the invention.

Returning to FIG. 3A, while the power generation system (300) is illustrated as being a component of the vessel (200), the power generation system (300) may be a component of another vessel, an on land installation, or otherwise not a component of the vessel (200) without departing from the invention. For example, the power generation system (300) may be a power plant on land or may be a power system of another vessel. The power plant or power system of the other vessel may be electrically connected to the vessel by one or more power distribution lines or structures and thereby may supply the power distribution system (310) with power.

To distribute the power generated by the power generation system (300), the vessel (200) may also include a power distribution system (310). The power distribution system (310) may receive each of the outputs (408, 418, 428, FIG. 4) of the generators (404-406, 414-416, 424-426, FIG. 4) and distribute the generated power to the drive systems (330-335). Each drive system may receive power from a portion of the generators by the power distribution system (310). As used herein, a portion of the generators refers to a discrete number of the generators. Additionally, as used herein, a portion of the electrical power of a portion of the generators refers to the aggregate of the power generated by each of the discrete generators of the portion of the generators.

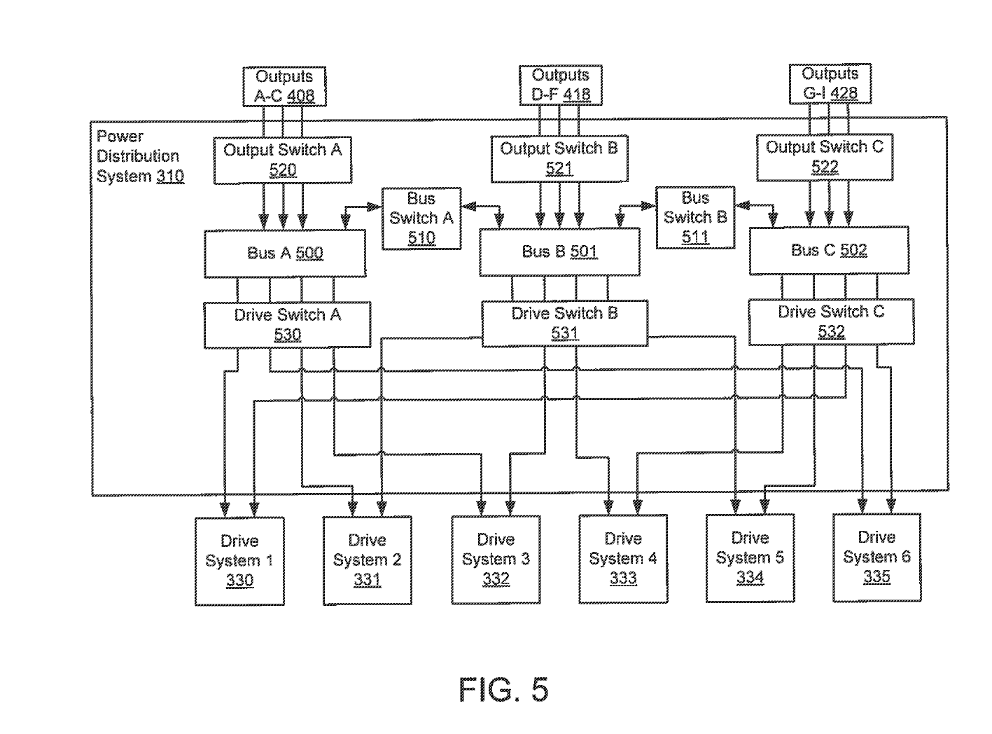

FIG. 5 shows a diagram of the power distribution system (310) in accordance with embodiments of the invention. The power distribution system includes multiple buses, e.g., Bus A (500), Bus B (501), and Bus C (502), for receiving and distributing electrical power. Each of the buses (500-502) may be connected to a number of the outputs of the generators and thereby receive electrical power. For example, in FIG. 5A Bus A (500) is connected to outputs A-C (408), Bus B (501) is connected to outputs D-F (418), and Bus C (502) is connected to outputs G-I (428).

Each bus (500, 501, 502) may be a physical structure that distributes the power to one or more of the drive systems (330-335). Each bus (500, 501, 502) may include heavy gauge wire or other electrically conducting structures that serve to conduct the electrical power from the outputs of the generators to the drive systems (330-335). Each bus (500, 501, 502) may also include one or more switches that may be used to route the received electrical power or electrically isolate one or more of the generators, drives systems, and/or buses.

Each bus (500, 501, 502) may be interconnected to the other busses by a bus switch (510, 511). Each of the bus switches (510, 511) may be operably connected to the control system (320, FIG. 3A) which controls when each of the aforementioned bus switches (510, 511) are open or closed. The bus switches (510, 511) may be, for example, electromechanical relays.

Bus switch A (510), for example, facilitates the connection and disconnection of Bus A (500) to Bus B (501). Bus switch B (511) provides a similar function for connecting Bus B (501) to Bus C (502), An additional switch (not shown) may provide a similar function for connecting Bus A (500) to Bus C (502).

Each bus (500, 501, 502) may also be connected to a set of generators by an output switch (520, 521, 522). Each of the output switches (520, 521, 522) may be operably connected to the control system (320, FIG. 3A) which controls when each of the aforementioned output switches (520, 521, 522) are open or closed. The output switches (520, 521, 522) may be, for example, electromechanical relays.

Output switch A (520), for example, facilitates the connection and disconnection of Bus A (500) to generators A-C (404-406). Output switch B (521) provides a similar function for connecting Bus B (501) to generators D-F (414-416). Output switch C (522) provides a similar function for connecting Bus C (502) to generators G-I (424-426). Thus, each of the output switches (520-522) may facilitate the connection and disconnection of a bus to or from a set of generators.

Each bus (500, 501, 502) may additionally be connected to one or more drive systems (330-335) by a drive switch (530, 531, 532). Each of the drive switches (530, 531, 532) may be operably connected to the control system (320, FIG. 3A) which controls when each of the aforementioned drive switches (530, 531, 532) are open or closed. The drive switches (530. 531, 532) may be, for example, electromechanical relays.

Drive switch A (530), for example, facilitates the connection and disconnection of drive systems 1, 2, 3, and 6 (330, 331, 332, 335) to Bus A (A). Thus, each of the output switches (530-532) may facilitate the connection and disconnection of drive systems from buses.

As seen from FIGS. 4 and 5, the power distribution system (310) may receive electrical power generated by the generators and distribute the received power to the drive systems (330-335, FIG. 3A), Each drive system may receive electrical power from two separate buses (500, 501, 502). For example, drive system 1 (330) receives power from Bus A (500) and Bus C (502). Drive system 2 (331, FIG. 3A) receives power from Bus A (500) and Bus B (501). Drive system 3 (332, FIG. 3A) receives power from Bus A (500) and Bus B (501). Drive system 4 (333, FIG. 3A) receives power from Bus B (501) and Bus C (502). Drive system 5 (334, FIG. 3A) receives power from Bus B (501) and Bus C (502). Drive system 6 (335, FIG. 3A) receives power from Bus A (500) and Bus C (502).

By distributing the electrical power as shown in FIGS. 4 and 5, each drive system (330-335) receives power from at least two buses. In the event of a bus level failure, e.g., an inability of a bus to supply power, each drive system may continue to receive power from another bus and thereby continue to be able to produce thrust. A bus level failure may be caused by, for example, a prime mover failure that renders generators unable to generate power, a cooling system failure of a generator that causes generators to overheat and thereby be unable to generate power, or a destructive event such as a fire that damages prime movers, generators, and/or the buses.

Returning to FIG. 3A, the vessel may include multiple drive systems (330-335). The drive systems (330-335) receive power from the power distribution system and produce thrust. Each of the drive systems (330-335) may be operably connected to a control system (320), which will be described in greater detail with respect to FIGS. 3A and 3B. The control system (320) controls the operation of each of the drive systems (330-335) to produce thrust that dynamically stabilizes the position of the vessel with respect to a wellsite, subsea equipment, geological formation, or other predetermined location.

Each of the drive systems (330-335) include delta-delta-wye transformers, variable frequency drives, and a thruster. The delta-delta-wye transformers receive power from the power distribution system and provide the received power to the variable frequency drives. The variable frequency drives, in turn, generate a variable frequency drive current which is supplied to the thruster. The thruster, in turn, produces thrust using the supplied variable frequency drive current.

In a first embodiment of the drive systems (330-335), the variable frequency drive currents generated by each variable frequency drive of a drive system are supplied to separate, independent windings of an electric motor of a thruster.

FIG. 6A shows a diagram of the first embodiment of the drive system I (330). Drive system 1 (330) receives electrical power from the power distribution system (310) via input 1 and input 2. Each of input 1 and input 2 are connected to separate buses of the electrical distribution system. The drive system includes two delta-delta-wye transformers (600, 601), two variable frequency drives (610, 611), and a thruster (620). Drive systems 2-6 (331-335) include similar components and perform similar functions to the embodiment of drive system 1 (330) shown in FIG. 6A.

Each of the delta-delta-wye transformers receive electrical current from different buses (500, 501, 502, FIG. 5A) of the power distribution system (310, FIG. 3A) via input 1 or input 2. In FIG. 6A, the first delta-delta-wye transformer (600) receives power from Bus A (500, FIG. 5A) via input 1 and the second delta-delta-wye transformer (601) receives power from Bus C (502, FIG. 5A) via input 2. As seen from FIG. 6A, a delta terminal of each transformer (600, 601) receives the power from each bus, respectively. Each transformer (600, 601) provides a portion of the received power to a variable frequency drive (610, 611) by a second delta terminal and a wye terminal. Providing the received power to each variable frequency drive (610, 611) may reduce and/or eliminate at least one harmonic current. For example, the aforementioned method of supplying the currents may reduce and/or eliminate the 5^{th} and/or 7^{th} harmonic currents.

Each transformer (600, 601) may also provide a second portion of the received power to one or more thrust directing motors (622) of the thruster (620), which will be described in greater detail below. While not shown in FIG. 6A, a power supply operably connected to the control system (320, FIG. 3A) may receive the second portion of the received power from each transformer and drive the thrust directing motors (622) using the second portion of the received power as directed by the control system (320, FIG. 3A).

The variable frequency drives (610, 611) may be physical devices including circuitry and/or electromechanical devices for convening alternating current to a variable frequency drive current. While not shown in FIG. 6A, the variable frequency drives (610, 611) may include inverters, power transistors, bus bars, or other circuitry or devices to facilitate the generation of the variable frequency drive currents. Additionally, the variable frequency drives may include circuity to synchronize the generated variable frequency drive currents. Alternatively, a separate controller (not shown) or the control system may synchronize the variable frequency drive current produced by the variable frequency drives. Additionally, the duty cycle, pulse width, current magnitude, or other characteristics of the variable frequency drive currents generated by the variable frequency drives may be synchronized by the separate controller, the control system, or other circuitry.

The variable frequency drives (610, 611) may receive the first portion of the power from the transformers (600, 601), and generate variable frequency drive currents using the received first portion of the power. As used herein, a variable frequency drive current is a configurable current, e.g., the frequency and amplitude of the generated current may be set. In one or more embodiments of the invention, the variable frequency drive current may be a pulse width modulated current. The variable frequency drives (610, 611) may supply the generated variable frequency drive currents to a thrust generation motor (621) of the thruster (620) which, in turn, produces thrust using the variable frequency drive currents.

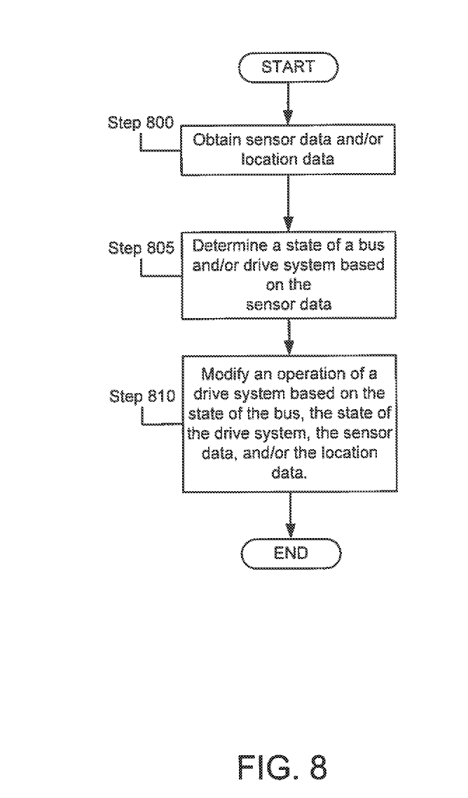

The variable frequency drives (610, 611) may be operably connected to the control system (320, FIG. 3A) and thereby the control system may control the magnitude of the thrust generated by the thruster (620) by modifying a magnitude, phase, or pulse width modulation of the variable frequency drive currents. As will be discussed in greater detail with respect to FIG. 8, the control system may independently set the magnitude, phase, or duty cycle of each variable frequency drive current generated by each variable frequency drive.

The thruster (620) of each drive system may include a thrust generation motor (621) coupled to a prop or other thrust generating mechanical structure. The thrust generation motor (621) may include at least two windings. The variable frequency drive currents generated by each variable frequency drive (610, 611), respectively, may be independently fed to each of the two windings of the thrust generation motor (621).

The thruster (620) of each drive system may include one or more thrust directing motors (622). As used herein, a thrust directing motor is a motor that may modify a direction of thrust generated by the thrust generation motor (621). The thrust directing motors (622) may, for example, modify the direction a prop or other thrust generating mechanical structure is facing to modify a direction of the thrust. The thrust directing motors may be powered by power received from both transformers (600, 601).

Thus, as seen from FIG. 6A, the thrust generation motor (621) and the one or more thrust directing motors (622) may receive power from at least two buses (500, 501, 502, FIG. 5). Accordingly, each of the aforementioned motors may he capable of operating when a bus level failure of one of the buses that supplies power to the motors occurs.

In one or more embodiments of the invention, each variable frequency drive (610, 611) may be capable of supplying 100% of the power required to drive the thrust generation motor (621). In other words, each of the variable frequency drives (610, 611) may be completely redundant. Thus, each thruster may be capable of supplying its maximum rated thrust even when one of the buses supplying power to one of the variable frequency drives (610, 611) fails.

In one or more embodiments of the invention, each variable frequency drive (610, 611) may be capable of supplying at least 50% of the power required to drive the thrust generation motor (621). In other words, each of the variable frequency drives (610, 611) may be partially redundant. Thus, each thruster may be capable of supplying at least 50% of the maximum rated thrust in the event of a bus level failure of a bus that supplies power to the motors.

In one or more embodiments of the invention, each variable frequency drive (610, 611) may be capable of supplying 54.54% of the power required to drive the thrust generation motor (621). The thrust generated by the propeller connected to the thrust generation motor (621) may not be linear. In other words, due to the hydrodynamic behavior of the propeller, the thrust generated by the propeller may not be directly proportional to the power supplied to the thrust generation motor (621). Thus, in some embodiments of the invention, a thruster (620) may provide a nominal thrust of 66.6% of the maximum rated thrust when receiving only 54.54% of the maximum rated drive power. Thus, in the event of a single bus failure, four thrusters may be capable of supplying 66.6% of the maximum rated thrust while two thrusters may be capable of supplying 100% of the maximum rated thrust resulting in a nominal thrust of 77.7% of the maximum available thrust without a bus failure.

In a second embodiment of the drive systems (330-335), the variable frequency drive currents generated by each variable frequency drive of a drive system are combined before being supplied to the thruster. FIG. 6B shows a diagram of a second embodiment of the drive system 1 (330). All of the components of the drive system shown in FIG. 6B are identical to similar components shown in FIG. 6A, except for the power combiner (615) and the thrust generation motor (621).

The power combiner (615) my receive the drive currents generated by each variable frequency drive (610, 611) and combine the drive currents. The power combiner (615) may be an electrical device. In addition to combining power, the power combiner may electrically isolate each variable frequency drive from each other variable frequency drive and thereby minimize or eliminate a change in a load of a variable frequency drive when another variable frequency drive is not operating. For example, when a bus level failure occurs, one of the drives of each drive system may not be operating. The power combiner (615) may isolate the inoperable variable frequency drive and thereby minimize or eliminate changes in the load seen by the variable frequency drive.

The thrust generation motor (621) of the second embodiment, in contrast to the first embodiment, may only include a single winding. Thus, the power combiner (615) may combine the variable frequency drive currents generated by each variable frequency drive (610, 611) and supply the combined currents to the single winding of the thrust generation motor (621).

While the thrust directing motors (622) shown in FIGS. 6A and 61 have been described as electrical motors, one of ordinary skill in the art will appreciate that other mixed motors such as electric-hydraulic motors, electric-pneumatic, or any other type of mixed motor may be used rather than an electric motor as a thrust direction motor without departing from the invention. Similarly, the thrust directing motors may not directly control a direction of the thrust without departing from the invention. For example, a thrust directing motor (622) in accordance with embodiments of the invention may only actuate other systems, compress fluids, or otherwise drive other mechanisms that directly control a direction of the thrust generated by a thrust generation motor (621).

To perform dynamic positioning, each of the embodiments of the drive systems (330-335, FIG. 3A) shown in FIGS. 6A and 6B may receive instructions from the control system to produce a quantity of thrust and direction of the thrust. The thrust of each of the drive systems may be used to dynamically position the vessel by setting the quantity and/or direction of thrust of each of the drive systems to maintain the position of the vessel. For example, the thrust of the drive systems may be used to counteract ocean currents.

In another example, the thrust of each drive system may be set to compensate for a failure of one or more of the buses of the power generation system. In the event of a bus level failure, one or more of the drive systems may receive a reduced amount of power which, in turn, reduces the quantity of generated thrust. The thrust of the other drive systems or the drive system receiving a reduced quantity of power may be adjusted to compensate for the reduced quantity of thrust.

Returning to FIG. 3A, the vessel includes a control system (320). The control system (320) may be one or more computing devices such as, for example, a mobile computer, desktop computer, server, router, switch, embedded device, or other types of hardware may be used. The control system (320) may be configured to dynamically position the vessel (200). The control system (320) may detect movement of the vessel (200) by one or more sensors and/or positioning systems and activate one or more drive systems to counteract the movement of the vessel (200), In one or more embodiments of the invention, the control system may perform dynamic positioning of the vessel (200).

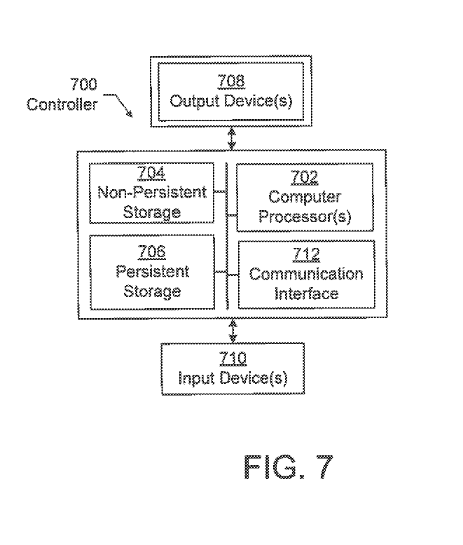

FIG. 3B shows a control diagram of the vessel (200) in accordance with embodiments of the invention. As seen from the control diagram, the control system (320) includes a master controller (321) and a slave controller (322). Each of the controllers may be a device as shown in FIG. 7.

Each of the controllers (321, 322) may be operably connected to each of the variable frequency drives (350) and thrust directing motors (351), e.g., FIG. 6A, FIG. 6B, of each of the drive systems. Each controller may be operably connected to the variable frequency drives (350) and thrust directing motors (351) by a first set of control lines (360) or a second set of control lines (361). Thus, each controller may be connected to each variable frequency drive and thrust directing motor by independent operable connections. While illustrated as a physical connection in FIG. 3B, the control lines (360, 361) may be wired connections or wireless connections without departing from the invention.

The control system (320) may obtain position, acceleration, and/or orientation data from multiple types and/or quantities of sensors. The types of sensors may include global positioning system(s) (340), acoustic sensor(s) (341), rotation sensor(s) (342), and/or acceleration sensor(s) (343). A global positioning system may be a sensor that determines a spatial location based on signals received from satellites. An acoustic sensor may be a sonar system that determines a distance from a location using acoustic measurements. A rotation sensor may be a gyroscope based sensor that determines a rotation of the vessel (200). An acceleration sensor may be an accelerometer that determines an acceleration of the vessel (200). The control system (320) may obtain data from other types of sensors without departing from the invention.

The control system (320) may obtain position, acceleration, and/or orientation data from any number of sensors of the aforementioned types of sensors. For example, the control system (320) may obtain acceleration data from three acceleration sensors (343) that are each aligned to one of three Cartesian axes to determine acceleration in three dimensions. In another example, the control system (320) may obtain acceleration data from three rotation sensors (342) that are each aligned to separate axes to determine rotation of the vessel about each of the three Cartesian axes. In a further example, data from multiple sensors or a type may be obtained and averaged to reduce noise and/or improve the accuracy of the estimate of the position, acceleration, and/or orientation of the vessel (200). In an additional example, data from multiple types of sensors may be obtained and compared to determine derived position, acceleration, and/or orientation, e.g. combining acceleration data over time and rotation data over time to estimate a position of the vessel (200).

The control system may use the obtained sensor data to perform dynamic positioning of the vessel (200). The sensor data from the sensors may be used to determine a position and/or orientation of the vessel. The determined position and/or orientation of the vessel may be compared to a location of a well and/or subsea equipment. The control system (320) may, based on the comparison, determine quantities and/or direction of thrust to maintain and/or modify the position of the vessel with respect to the location of the well and/or subsea equipment to prevent damages to risers and/or other connections between the vessel and the well and/or subsea equipment. The control system (320) may send control signals to the variable frequency drives (350) and/or thrust directing motors (351) to produce the determined quantity and/or direction of thrust.

In one or more embodiments of the invention, the slave controller (322) operates as a backup for the master controller (321). For example, each of the master controller (321) and the slave controller (322) may independently determine the quantity and/or direction of thrust. Only the master controller (321) may send control signals to each of the variable frequency drives (350) and/or thrust directing motors (351) while the master controller (321) is operational. In the event of a failure of the master controller (321), the slave controller (322) sends the control signals to each of the variable frequency drives (350) and/or thrust directing motors (351). The master controller (321) and slave controller (322) may be operably connected, as indicated in FIG. 3B, and may periodically poll each other to verify that each controller is consistently determining the same quantity of thrust and/or direction of thrust to be generated based on the sensor data. Any method for maintaining the consistency of the data and/or determinations of each controller may be employed without departing from the invention.

In one or more embodiments of the invention, the master controller (321) and the slave controller (322) operate in parallel and each of the controllers sends control signals to one of the variable frequency drives (350) and/or thrust directing motors (351) of each drive system. For example, each of the master controller (321) and the slave controller (322) may independently determine the quantity and/or direction of thrust and each controller may send control signals to half of the variable frequency drives and/or thrust directing motors of the vessel. In some embodiments of the invention, the master controller (321) sends signals to a first variable frequency drive and/or first associated thrust directing motor of each drive system and the slave controller (322) sends signals to a second variable frequency drive and/or second associated thrust directing motor of each drive system. In the event of a failure of the master controller (321) or the slave controller (322), the controller that remains operational sends control signals to each of the variable frequency drives (350) and/or thrust directing motors (351). The master controller (321) and slave controller (322) may be operably connected, as indicated in FIG. 3B, and may periodically poll each other to verify that each controller is consistently determining the same quantity of thrust and/or direction of thrust to be generated based on the sensor data.

In one or more embodiments of the invention, one or more of the sensors may determine a state of a generator and the thrust generated by each drive system may be set based on, in part, the state of the generator. The control system (320) may be configured to perform the method shown in FIG. 8.

FIG. 7 shows a controller (700) in accordance with embodiments of the invention. The controller (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), and numerous other elements and functionalities.

The computer processor(s) (702) may be an integrated circuit for processing instructions. For example, the computer processor(s) may be one or more cores or micro-cores of a processor. The controller (700) may also include one or more input devices (710), such as a touchscreen, keyboard, mouse, microphone, touchpad, electronic pen, or any other type of input device.

The non-persistent storage (704) may be a computer readable storage medium for temporarily storing data. The non-persistent storage (704) may be, for example, random access memory. The non-persistent storage (704) may take other (bans without departing from the invention. In one or more embodiments of the invention, data from the sensors operably connected to the control system may be stored in the non-persistent storage.

The persistent storage (706) may be a computer readable storage medium for storing data. The persistent storage (706) may be, for example, a hard disk drive or a solid state drive. The persistent storage (706) may take other forms without departing from the invention. In one or more embodiments of the invention, data from the sensors operably connected to the control system may be stored in the non-persistent storage. In one or more embodiments of the invention, the persistent storage (706) may include computer readable instructions that when executed by the processors (702) provide the control system with the functionality described with respect to FIG. 3B.

The communication interface (712) may include an integrated circuit for connecting the controller (700) to the drive systems (330-335), the switches (530-534), the bus switches (510, 511), the variable frequency drives (610, 611), other components of the vessel (100), or any of the connections shown in FIG. 3B. The connections may be direct connections or indirect connections by a network (not shown) (e.g., a local area network (LAN), a wide area network (WAN) such as the Internet, mobile network, or any other type of network) and/or to another device, such as another controller.

Further, the controller (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing systems exist, and the aforementioned input and output device(s) may take other forms.

Software instructions in the form of computer readable program code to perform one or more embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by one or more processors, is configured to perform one or more embodiments of the invention, such as the method shown in FIG. 8.

FIG. 8 shows a flowchart in accordance with one or more embodiments of the technology. The flowchart illustrates a method for dynamically positioning a vessel with respect to a predetermined location. The location may be a wellsite, a subsea equipment, a geological formation, or other location. While the various steps in this flowchart are presented and described sequentially, one of ordinary skill will appreciate that at least some of the steps may be executed in different orders, may be combined or omitted, and at least some of the steps may be executed in parallel.

In Step 800, sensor data and/or location data is obtained. The sensor data may be obtained by a control system of a vessel from one or more sensors. Similarly, the motion data may be obtained by the control system from one or more location sensors. For example, the control system may be the control system (320) shown in FIG. 3B. The control system (320) may be connected to the sensors by one or more operable connections and communicate with the sensors by a communication interface (712). Similarly, the control system (320) may be connected to a navigation system by one or more operable connections and communicate with the navigation system by the communication interface (712).

The obtained sensor data may indicate the presence of one or more forces acting on the vessel. For example, the sensor data may indicate the presence of an ocean current that is acting on the vessel. The sensors may be inertial sensors, fluid velocity sensors, strain gauges, or any other type of force and/or motion sensing devices. The obtained sensor data may also indicate an operating state of one or more components of the vessel. For example, the sensor data may indicate the operational state of a generator of the vessel that supplies power to a drive system of the vessel. The operational state of the generator may be a power generation capacity of the generator. In the event of a failure of a generator, the operational state of the generator specifies that the generator is unable to generate power. The sensors may be current, voltage, or power sensors that indicate power generation and/or consumption. The sensors may be thermal sensors such as thermocouples that indicate a thermal state of a component of the vessel. The sensors may be force sensors such as strain gauges that indicate a mechanical state of a component of the vessel.

The obtained location data may indicate the location of the vessel. For example, a navigation system of the vessel may be based on a global positioning system that is capable of determining the location of the vessel at any time. However, embodiments of the navigation system are not limited to a global positioning system, e.g., satellite based navigation system. The navigation system may be any type of navigation system such as, for example, a gyroscope based navigation system, a radar based navigation system, an echolocation based navigation system, or any other type of navigation system that may be used to determine the location of the vessel.

In Step 805, a state of a bus and/or drive system is determined based on the sensor data. The state of the bus and/or drive system may be determined by the control system. For example, the state of the bus may be a generation capacity of a number of generators that supply power to the bus. The generation capacity of the generators may be determined based on the sensor measurements of the current, voltage, and/or power produced by the generators. The sensor measurements may be compared to predetermined values to determine an operating state of the generators. The predetermined values may be set by a user and may be stored in a memory of the control system.

In another example, the state of the bus may be determined based on a future generation capacity of the generators that supply power to the bus. The future generation capacity of the generators may be determined based on the sensor measurements of the thermal state of a portion of the generators and/or the mechanical state of a portion of the generators. The thermal and/or mechanical state indicate that the portion of the generators will become inoperable or have a reduced operating capacity in the future. The sensor measurements may be compared to predetermined values to the future generation capacity of the generators.

In a further example, the state of the drive system may be a current and/or future operating state of the drive system. The operating state of the drive system may be determined based on sensor measurements of the thermal state of the drive system and/or the mechanical state of the drive system. The thermal and/or mechanical state of the drive system may indicate that the drive system will become inoperable or have a reduced operating capacity in the future. The sensor measurements may be compared to predetermined values to determine a current or future generation capacity of the generator.

In Step 810, the operation of a drive system is modified based on the state of the bus and/or a drive system, the sensor data, and/or the location data. The operation may be modified by the control system by sending a message to the drive system being modified that specifies the modified operation. The modified operation may be, for example, increasing thrust generation, decreasing thrust generation, and/or directing the generated thrust in a direction specified in the message.

The control system may determine the modification of the drive system by comparing the state of the bus and/or a drive system, the sensor data, and/or the location data to dynamic position data stored in a memory of the control system. The dynamic position data may be a look up table that specifies an operation of each drive system based on the state of the bus and/or a drive system, the sensor data, and/or the location data to dynamic position data stored in a memory of the control system.

The control system may compare the current operation of each drive system to the operation of each drive system specified by the look up table and determine a modification of the drive system based on the comparison. For example, a current operation of a drive system may be to produce a thrust of 100 horsepower. The control system may look up the operation of the drive system specified by the dynamic position data. The specified operation of the drive system may be to produce a 150 horsepower thrust for the state of the bus and/or a drive system, the sensor data, and/or the location data. The control system may compare these values, e.g., 100 horsepower and 150 horsepower, and determine a modification, e.g., increasing the thrust to 150 horsepower. The control system may send a message to the drive system specifying the modification, e.g., generation of a thrust of 150 horsepower, and the drive system may modify its thrust generation to match the specified modification. The method may end following step 810.

Thus, the method shown in FIG. 8 may be used to perform dynamic positioning of a vessel.

To further clarify embodiments of the invention, the following example is provided. The example is not intended to limit the scope of the invention and is included for explanatory purposes only.

### EXAMPLE 1

A vessel shown in FIG. 3A may be operating in the Gulf of Mexico and performing field operations. The field operations are performed by way of risers linking the vessel to a subsea equipment of a well.

While performing the field operations, a local ocean current may increase from 4 knots to 8 knots. A control system of the vessel detects, by sensor measurements, that the vessel has started to drift away from the subsea equipment due to the increased current. In response to the detected drifting, the control system sets a thrust generation rate of two out of six thrusters at a higher rate. The higher thrust rate of the two thrusters stops the vessel from drifting.

While generating the higher thrust rate, three generators of the vessel that supply power to a bus fails. The control system of the vessel detects, by a sensor monitoring the generators, that three generators are unable to continue to supply power to the bus. Based on the failure, the control system determines that the thrust generation rate of two thrusters needs to be increased to dynamically position the vessel.

The control system signals the variable frequency drives associated with the two thrusters to increase the power supplied to the thrust generation motors of the two thrusters. The increased thrust provided by the two thrusters stops the vessel from drifting due to forces from the local environment that are acting on the vessel.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for dynamic positioning of a vessel, comprising:
a plurality of generators that generate electrical power;
a power distribution system comprising:
a first bus that obtains a first portion of the electrical power from a first portion of the plurality of generators;
a second bus that obtains a second portion of the electrical power from a second portion of the plurality of generators; and
a thruster that generates thrust using the first portion of the electrical power and the second portion of the electrical power.

2. The system of claim 1, wherein the first portion of the plurality of generators and the second portion of the plurality of generators are different generators.

3. The system of claim 1, further comprising:
a first delta-delta-wye transformer that receives the first portion of the electrical power;
a second delta-delta-wye transformer that receives the second portion of the electrical power;
a first variable frequency drive that generates a first variable frequency drive current using power received from the first delta-delta-wye transformer; and
a second variable frequency drive that generates a second variable frequency drive current using power received from the second delta-delta-wye transformer,
wherein the thruster generates the thrust using the first variable frequency drive current and the second variable frequency drive current.

4. The system of claim 3, wherein the first variable frequency drive receives power from the first delta-delta-wye transformer via a first connection to a wye terminal of the first delta-delta-wye transformer and a second connection to a delta terminal of the first delta-delta-wye transformer.

5. The system of claim 3, wherein the first variable frequency drive current has a first magnitude, wherein the second variable frequency drive current has a second magnitude, wherein the first magnitude and the second magnitude are different.

6. The system of claim 3, wherein the first variable frequency drive current has a first frequency, wherein the second variable frequency drive current has a second frequency, wherein the first frequency and the second frequency are different.

7. The system of claim 3, wherein the system further comprises:
a controller configured to:
obtain a state of the first bus;
determine a quantity of thrust to be generated by the thruster based on, at least in part, the state of the first bus;
set a parameter of the first variable frequency drive current based on the quantity of thrust to be generated; and
set a parameter of the second variable frequency drive current based on the quantity of thrust to be generated.

8. The system of claim 7, wherein the state of the first bus is obtained by:
obtaining sensor data from a sensor monitoring the first bus;
comparing the sensor data to a predetermined value; and
determining the state of the first bus based on the comparison.

9. The system of claim 8, wherein the sensor data is a measurement of a magnitude of the first portion of the electrical power.

10. The system of claim 7, wherein the parameter of the first variable frequency drive current is a magnitude of the first variable frequency drive current.

11. The system of claim 7, wherein the parameter of the first variable frequency drive current is a frequency of the first variable frequency drive current.

12. The system of claim 7, wherein the parameter of the second variable frequency drive current is a magnitude of the second variable frequency drive current.

13. The system of claim 7, wherein the parameter of the second variable frequency drive current is a frequency of the second variable frequency drive current.

14. The system of claim 3, wherein the thruster comprises:
a thrust generation motor that generates the thrust; and
a thrust directing motor that directs the thrust,
wherein the thrust generation motor comprises:
a first winding that receives the first variable frequency drive current; and
a second winding that receives the second variable frequency drive current.

15. The system of claim 3, wherein the drive system further comprises:
a combiner that:
receives the first variable frequency drive current;
receives the second variable frequency drive current; and
generates a combined variable frequency drive current using the first variable frequency drive current and the second variable frequency drive current,
wherein the thruster comprises:
a thrust generation motor that generates the thrust; and
a thrust directing motors that directs the thrust,
wherein the thrust generation motor comprises;
a first winding drat receives the first variable frequency drive current; and
a second winding that receives the second variable frequency drive current.

16. A method for performing dynamic positioning of a vessel, comprising:
obtaining a state of a bus of the vessel;
determining a quantity of thrust to be generated by a thruster of the vessel based on, at least in part, the state of the bus; and
setting a thrust generation rate of a thruster of the vessel based on the quantity of thrust to be generated.

17. The method of claim 17, wherein the bus supplies power to the thruster.

18. The method of claim 17, wherein the bus supplies power to a second thruster.

19. The method of claim 17, wherein the state of the bus specifies a quantity of power received by the bus.

20. The method of claim 17, wherein the state of the generator specifies a temperature of the bus.
